(19) United States
(12) Patent Application Publication
(10) Pub. No.: US 2026/0177979 A1
(43) Pub. Date: Jun. 25, 2026

(54) TIMEPIECE

(71) Applicant: CASIO COMPUTER CO., LTD., Tokyo (JP)

(72) Inventors: Ryuma IZUMI, Tokyo (JP); Noriyuki KITTA, Tokyo (JP)

(73) Assignee: CASIO COMPUTER CO., LTD., Tokyo (JP)

(21) Appl. No.: 19/409,924

(22) Filed: Dec. 5, 2025

(30) Foreign Application Priority Data
Dec. 19, 2024 (JP) 2024-223858

(51) Int. Cl. G04B 19/04; G04B 19/06; G04G 17/00

(52) U.S. Cl. CPC G04B 19/042; G04B 19/06; G04G 17/00

(57) ABSTRACT

A timepiece including: a dial on which a first sign and a second sign are arranged, the first sign indicating a first display content and the second sign indicating a second display content which is different from the first display content; and a hand that moves above the dial. The hand has a through hole to allow visibility of the dial arranged below the hand, and the first sign and the second sign are arranged at a position through which the through hole passes when the hand is moved.

### REFERENCE TO RELATED APPLICATIONS

The entire disclosure of Japanese Patent Application No. 2024-223858 filed on December 19, 2024, including description, claims, drawings and abstract is incorporated herein by reference.

### TECHNICAL FIELD

The present disclosure relates to a timepiece.

### DESCRIPTION OF RELATED ART

In the past, a technology has been disclosed in which hour and minute hand window holes are arranged in the hour and minute hands of hands and hand instruments, and the scales on the dial can be seen through each window hole (see, for example, JP 2021-148665 A).

### SUMMARY OF THE INVENTION

A timepiece reflecting one aspect of the present disclosure comprises: a dial on which a first sign and a second sign are arranged, the first sign indicating a first display content and the second sign indicating a second display content which is different from the first display content; and a hand that moves above the dial, wherein the hand has a through hole to allow visibility of the dial arranged below the hand, and the first sign and the second sign are arranged at a position through which the through hole passes when the hand is moved.

### BRIEF DESCRIPTION OF DRAWINGS

FIG. 1 shows an example of the appearance of a timepiece in an embodiment.

FIG. 2 is a block diagram showing the schematic functional configuration of the timepiece in FIG. 1.

FIG. 3A shows the configuration of a magnetic hand.

FIG. 3B shows the configuration of the magnetic hand.

FIG. 4A shows an example of luminescent parts provided on minute and hour hands, showing an example of a case where the minute and hour hands do not overlap.

FIG. 4B shows an example of the luminescent parts provided on the minute and hour hands, showing an example of a case where the minute and hour hands overlap.

FIG. 5A shows the state of the minute hand when it overlaps a first sign.

FIG. 5B shows the state of the hour hand when it overlaps the first sign.

FIG. 6A shows the state of the minute hand when it overlaps a second sign.

FIG. 6B shows the state of the hour hand when it overlaps the second sign.

FIG. 7 shows an example where the first sign is arranged where the hour and minute hands overlap.

FIG. 8 shows how the hour and minute hands overlap, making it difficult to see part of the first sign.

### DETAILED DESCRIPTION

The following is a description of the form in which the present disclosure is to be implemented, with the aid of drawings. However, the embodiments described below are subject to various limitations that are technically preferred for implementing the present disclosure. Therefore, the technical scope of the present disclosure is not limited to the following embodiments and illustrative examples.

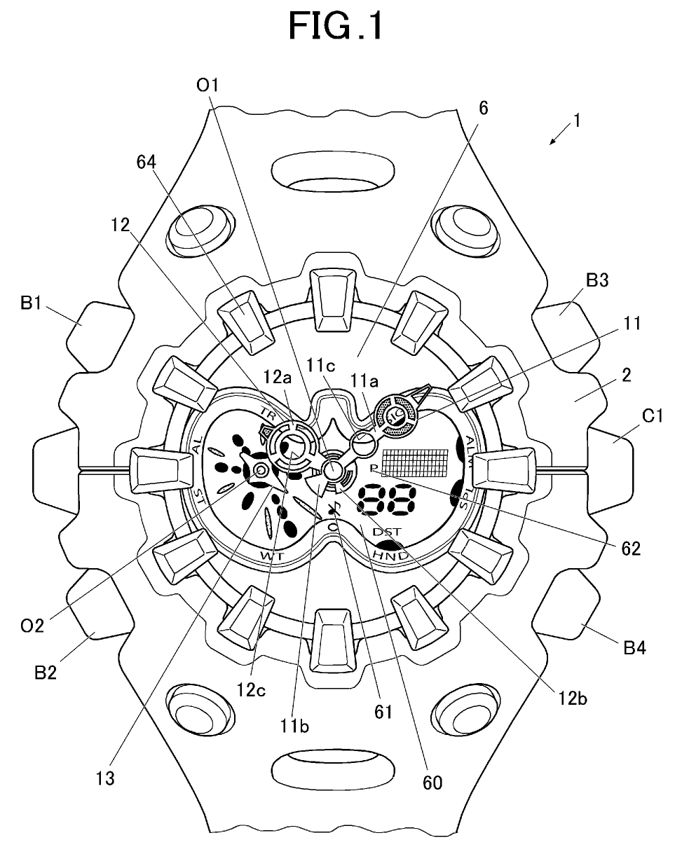

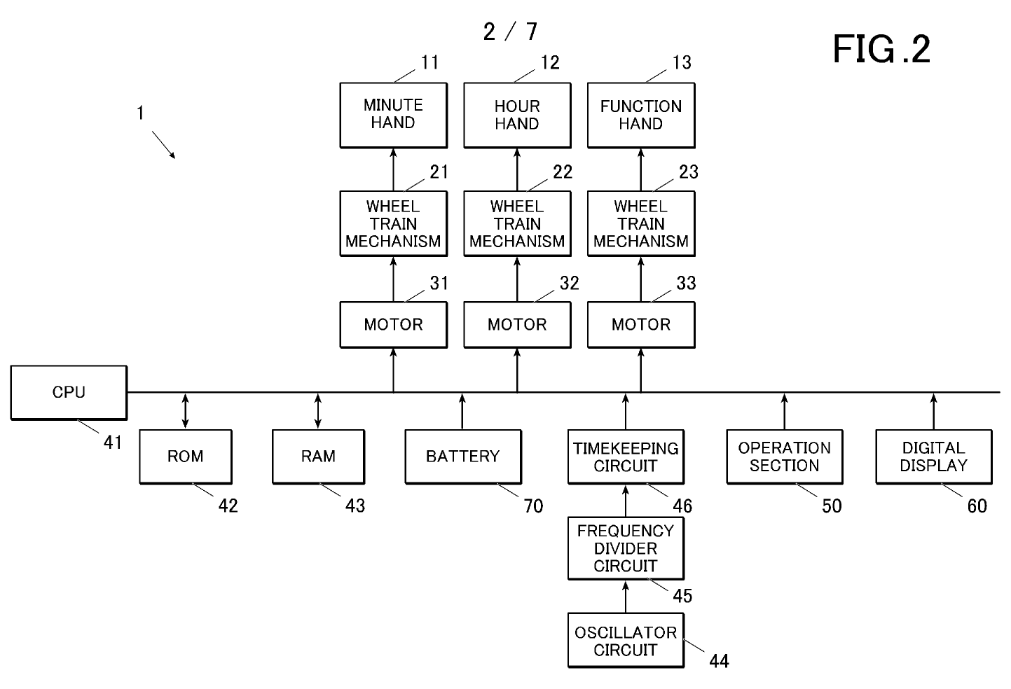

First, the configuration of the timepiece 1 in the present disclosure will be described. In this application, “above" and “below" shall be defined based on when the face of the dial 6 is arranged face up. The timepiece 1 is a wristwatch- type timepiece, as shown, for example, in FIG. 1. As shown in FIG. 2, timepiece 1 comprises a CPU (Central Processing Unit) 41 including at least one processor, a ROM (Read Only Memory) 42, a RAM (Random Access Memory) 43, an oscillator circuit 44, a frequency divider circuit 45, and a timekeeping circuit 46. Furthermore, the timepiece 1 is configured by including motors 31-33, wheel train mechanisms 21-23, a minute hand 11, an hour hand 12, a function hand 13, an operation section 50, a digital display 60, and a battery 70.

The CPU 41 controls the operation of the timepiece 1 by loading and executing a program from the ROM 42 to the RAM 43 to provide the time display function and other functions, and to switch between these functions. The CPU 41 functions as a processor.

The ROM 42 is a nonvolatile memory that stores programs and various data that control the operation of the timepiece 1, such as the time display function. The RAM 43 is a volatile or nonvolatile memory that temporarily stores programs stored in the ROM 42 and temporary data necessary to control the operation of the timepiece 1.

The oscillator circuit 44 generates a predetermined frequency signal using, for example, a crystal oscillator and outputs it to the frequency divider circuit 45. The frequency divider circuit 45 divides the frequency signal and outputs it to the timekeeping circuit 46 and the CPU 41. The timekeeping circuit 46 calculates the current date and time by counting the signals input from the frequency divider circuit 45 and adding them to the initial value, and outputs the calculated result to the CPU 41. The oscillator circuit 44, frequency divider circuit 45, and timekeeping circuit 46 constitute the timekeeper.

The operation section 50 has buttons B1 to B4 shown in FIG. 1, accepts press operations from the user, and outputs signals to the CPU 41 in response to the press operations. The operation section 50 is also equipped with a crown C1.

The motors 31-33 rotate under instruction of the CPU 41. The motor 31 operates the minute hand 11 through the wheel train mechanism 21, which is an array of multiple gears, to rotate the minute hand around the axis O1. The motor 32 causes the hour hand 12 to rotate around the axis O1 via the wheel train mechanism 22. The motor 33 causes the function hand 13 to rotate around the axis O2 via the wheel train mechanism 23.

The digital display 60 is composed of a display screen such as a liquid crystal display, organic EL (Electro Luminescence), etc., and performs various displays according to the instructions of the CPU 41. The battery 70 supplies power to the various parts of the timepiece 1. The battery 70 is, for example, a secondary battery charged by a solar cell, not shown.

Inside the housing 2 of the timepiece 1 shown in FIG. 1 is a dial 6 whose top surface is covered by a transparent windshield, which is not shown in the figure. The dial 6 in the present embodiment is circular, as shown in FIG. 1, and hour characters 64 (indexes) and a scale not shown are arranged along the circumferential direction of the dial 6. At the center of the dial 6 are the minute hand 11 and hour hand 12 and their rotation axis, axis O1. The minute hand 11 and hour hand 12 display the time by rotating, above the dial 6, around the axis O1 and pointing to the hour character 64 or scale as appropriate.

The timepiece 1 is designed with a large minute hand 11 and hour hand 12. Conventionally, when enlarging hands such as the minute hand 11 and hour hand 12, it was necessary to increase the size of the rear end (tail) on the rear side of the hand from the rotation axis, and to maintain weight balance, in order to prevent the hands from tilting and affecting rotation. In the present embodiment, for the larger and longer minute hand 11, a magnetic hand with magnetic body is used, so there is less need to consider the weight balance between the distal end 11a on the distal side and the rear end 11b on the rear side with respect to the axis O1 in the minute hand 11. Therefore, the rear end 11b of the minute hand 11 is shortened so that the sign (e.g., the first sign 61) displayed near the axis O1 on the dial 6 is not hidden by the rear end 11b. In other words, the sign (e.g., the first sign 61, etc.) displayed near the axis O1 on the dial 6 is arranged at a position not hidden by the rear end 11b. The hour hand 12 may also use a magnetic hand.

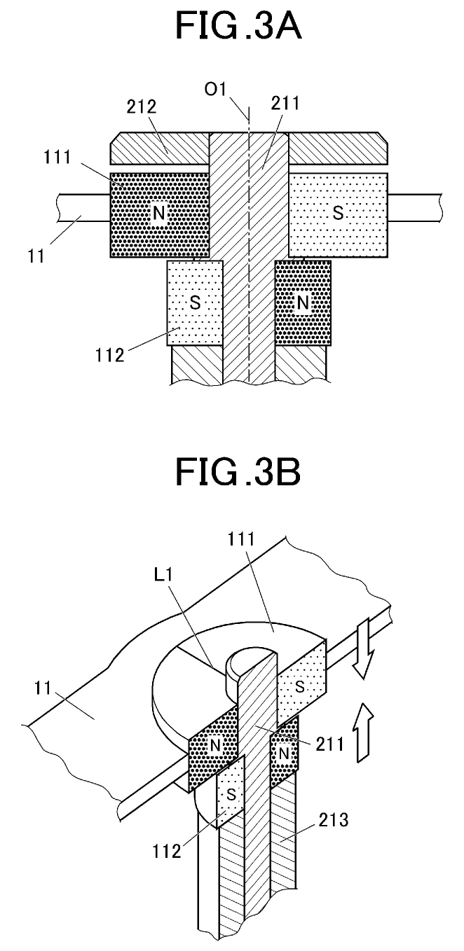

In the present embodiment, the timepiece 1 has a driven magnet 111 (first magnetic body) and a drive magnet 112 (second magnetic body) located below the driven magnet 111 (lower in the axial direction) and arranged opposite the driven magnet 111, as shown in FIGS. 3A and 3B. The driven magnet 111 and the drive magnet 112 are composed of a ferromagnetic body such as samarium cobalt, for example. The driven magnet 111 and the drive magnet 112 are annular magnets arranged around the axis O1, magnetized in the radial direction and having two different poles in the circumferential direction. For example, it is polarized to S-pole in one direction and N-pole in the other direction, bounded by the radial polarization line L1 passing through the center.

A driven magnet 111 is fixed to the minute hand 11. The driven magnet 111 and the drive magnet 112 are rotatably supported around the axis O1 by the support member 211. The drive magnet 112 is fixed to the wheel train mechanism 21 via a support member 211 and a shaft body 213. The S and N poles of the driven magnet 111 and the drive magnet 112 attract each other, and the minute hand 11 is held in balance with the distal end 11a and the rear end 11b. This allows the rear end 11b of the minute hand 11 to be shortened, and the sign can be arranged near the axis O1 but not hidden by the rear end 11b. In addition, even if the minute hand 11 is displaced by an impact, etc., no more rotational torque than the constraining force exerted by the magnetic forces of the drive magnet 112 and the driven magnet 111 is applied, thus preventing damage to the movement interior, such as the wheel train mechanism 21, due to external forces. Even if the positional relationship between the driven magnet 111 and the drive magnet 112 is misaligned due to impact or other causes and repulsive forces between the same poles are generated, the driven magnet 111 will return to its original positional relationship without slipping out of the axis O1 because it is regulated by the regulating member 212.

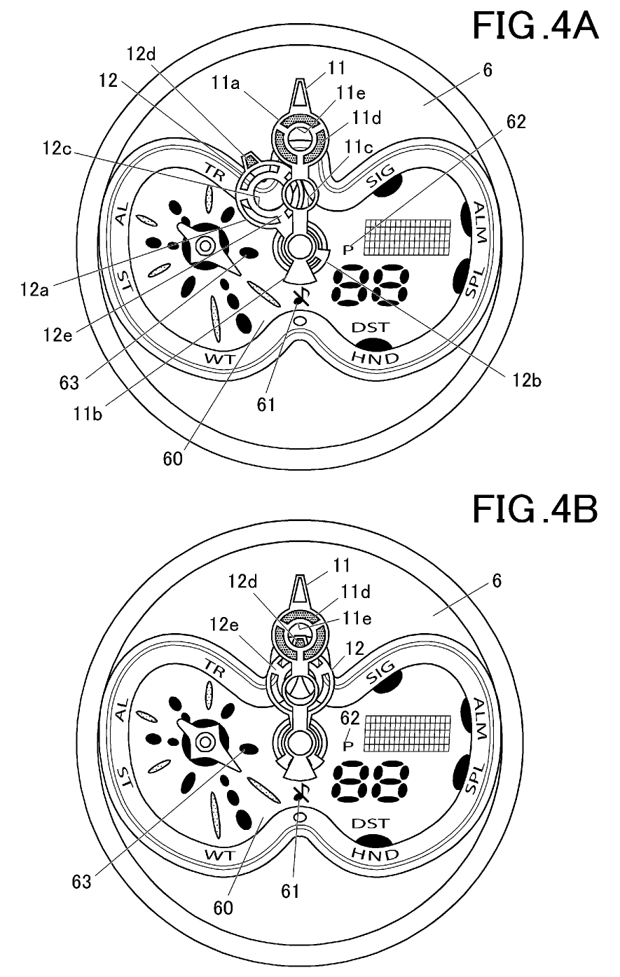

The minute hand 11 and hour hand 12 have through holes 11c and 12c that make the dial 6 visible in plan view, as shown in FIGS. 1, 4A to 8. This allows the user to see the signs (e.g., the first sign 61, etc.) arranged on the dial 6, through the through holes 11c and 12c, where the minute hand 11 and hour hand 12 are passing through. Here, the hour hand 12 is slower than the minute hand 11, so it takes longer to pass over a single sign. Therefore, the through hole 12c in the hour hand 12 is larger than the through hole 11c in the minute hand 11. This prevents the sign under the hour hand 12 from being hidden for long periods of time. On the other hand, if the through hole 12c is made too large, the durability of the hour hand 12 would be reduced. Therefore, the hour hand 12 has a support 12e (see FIGS. 4A and 4B) that supports the through hole 12c to improve the durability of the hour hand 12.

The minute hand 11 and hour hand 12 have luminescent parts 11d and 12d coated with luminescent paint so that the user can see the position of the minute hand 11 and hour hand 12 even in the dark. The shapes of the luminescent parts 11d and 12d are different from each other. For example, as shown in FIG. 4A, the luminescent part 11d of the minute hand 11 is annular and is located on the distal side of the minute hand 11. The luminescent part 12d of the hour hand 12 is provided at the distal end and is trapezoidal in shape. The different shapes of the luminescent part 11d and the luminescent part 12d allow the user to identify the minute hand 11 and the hour hand 12 in the dark. In the present embodiment, the luminescent part 11d of the minute hand 11 has a through hole 11e (window hole), and as shown in FIG. 4B, the luminescent part 12d of the hour hand 12 is provided at a position where it is visible through the through hole 11e of the luminescent part 11d when the minute hand 11 and hour hand 12 overlap. This allows the user to see the luminescent part 12d of the hour hand 12 even when the minute hand 11 overlaps the hour hand 12.

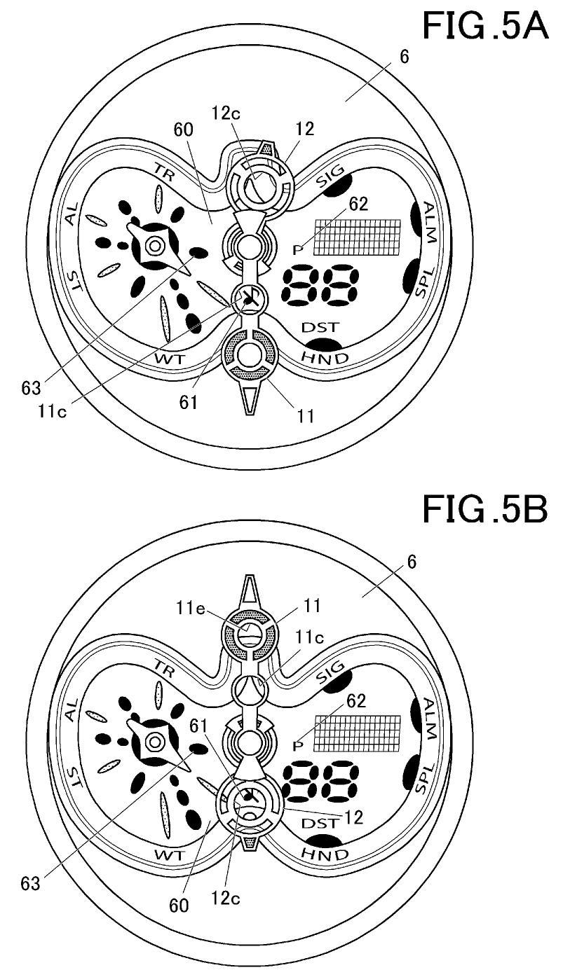

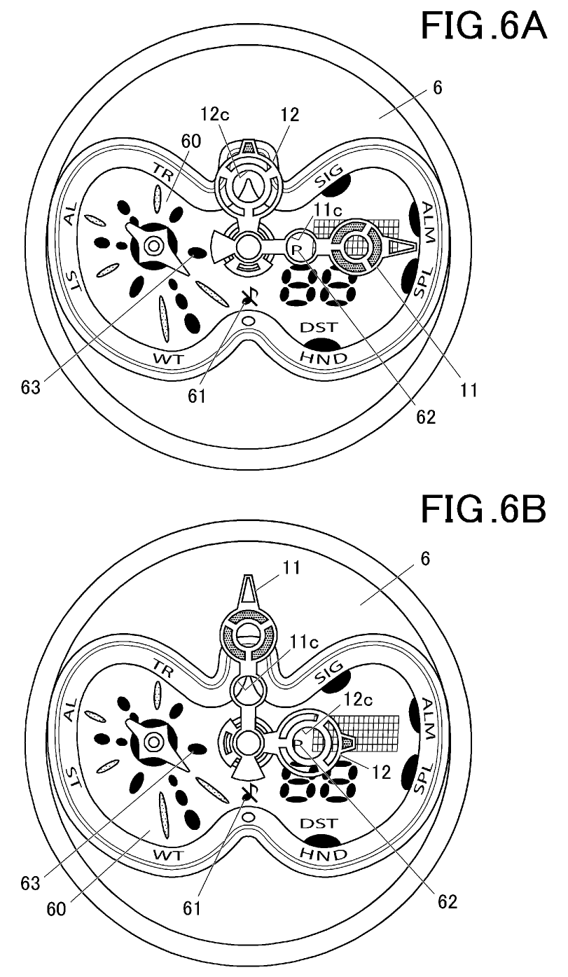

The dial 6 has a digital display 60 that can display various information in addition to the time. The digital display 60 is a display area capable of digitally displaying various types of information, for example, by liquid crystal. As shown in FIGS. 5A and 5B, etc., the digital display 60 has multiple signs that differ from each other in shape and display content, and that are arranged (and can be displayed) in sizes that fit into the through holes 11c and 12c. These signs are icons that can light on or off and are displayed at predetermined timings. For example, the digital display 60 has a first sign 61 that lights up during a muted state to indicate the muted state (first display content), a second sign 62 that indicates AM/PM (second display content), and a third sign 63 that indicates seconds count. These signs are arranged at the positions (on the circumference) where the through holes 11c and 12c pass through when the minute hand 11 and hour hand 12 are moved to the positions corresponding to these signs. Thus, as shown in FIGS. 5A to 6B, the user can see these signs through the through hole 11c or 12c even when the minute hand 11 and hour hand 12 pass over these signs. The first sign 61 is arranged in 6 o’clock direction on the dial 6, the second sign 62 is in 3 o’clock direction on the dial 6, and the third sign 63 is in 9 o’clock direction on the dial 6. The first sign 61 through third sign 63 are arranged apart from each other, so that even if there is a timing when a sign is hidden by a hand, it is possible to prevent multiple signs from being hidden at one time.

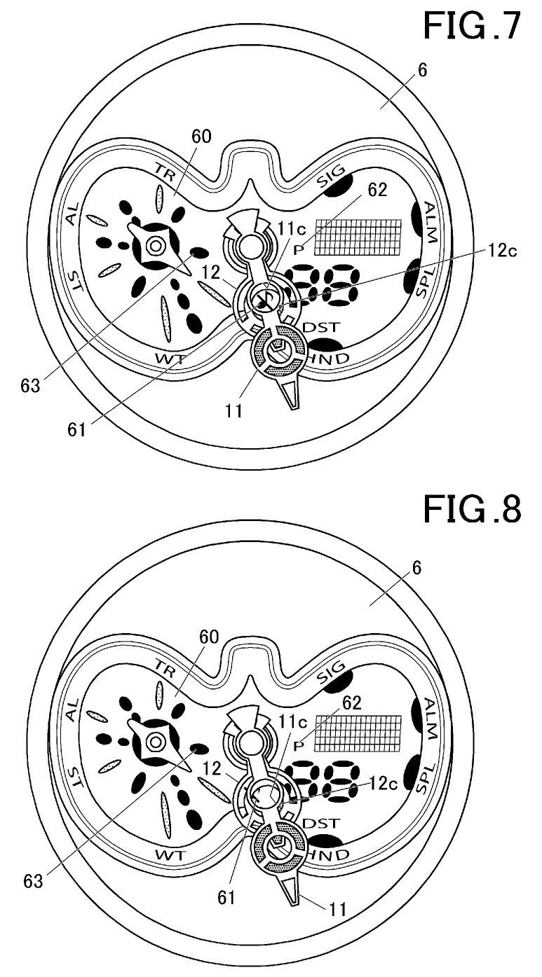

As shown in FIG. 7, the first sign 61 to third sign 63 may be arranged at the positions where the through hole 11c in the minute hand 11 and the through hole 12c in the hour hand 12 overlap when the minute hand 11 and hour hand 12 overlap.

In the present embodiment, the position of the first sign 61 to third sign 63 is fixed, but the position of the first sign 61 to third sign 63 may be variable to match the position of the minute hand 11 and hour hand 12. For example, in FIG. 8, the first sign 61 is visible but difficult to see because it partially overlaps the through hole 11c and the through hole 12c. Therefore, the CPU 41 estimates the positions of the minute hand 11 and hour hand 12 based on the current time information output from the timekeeping circuit 46. The CPU 41 then controls the digital display 60 to shift the positions of the first sign 61 to third sign 63 according to the estimated positions. For example, if the CPU 41 determines, based on the estimated positions of the minute hand 11 and hour hand 12, that any part of any of the first sign 61 to third sign 63 is hidden by the minute hand 11 or hour hand 12, it controls the digital display 60 to shift the position of the hidden sign among the first sign 61 to third sign 63 below the through hole 11c or through hole 12c. This allows displaying the first sign 61 to third sign 63 to be easily visible at all times.

The CPU 41 may also estimate the position of the minute hand 11 and hour hand 12 based on the current time information output from the timekeeping circuit 46 and not display the portion of the digital display 60 that is covered by the minute hand 11 or hour hand 12. This reduces power consumption. In addition, visibility can be improved by preventing the display from becoming difficult to see due to unnecessary display.

As explained above, the timepiece 1 is equipped with a dial 6 on which are arranged signs including a first sign 61 indicating the first display content and a second sign 62 indicating the second display content different from the first display content, and a minute hand 11 and an hour hand 12 that move above the dial 6. The minute hand 11 and hour hand 12 have through holes 11c and 12c to allow visibility of the dial 6 arranged below them. The first sign 61 and the second sign 62 are arranged where the through holes 11c and 12c pass through when the minute hand 11 and the hour hand 12 are moved to the position corresponding to the first sign 61 or the second sign 62, respectively. In addition to scales for time display, the dials of timepieces are increasingly displaying various signs indicating various contents. In the conventional technology, however, the minute and hour hands hide the signs on the dial, resulting in a loss of visibility. According to the present disclosure, the signs on the dial 6 are no longer hidden by the minute hand 11 and hour hand 12 compared to the conventional technology, thereby improving the visibility of the signs on the dial 6.

The first sign 61 and the second sign 62 are different in shape from each other. Thus, the visibility of each of the first sign 61 and second sign 62, which differ in display content and shape, arranged on the dial 6 can be improved.

For example, a driven magnet 111 disposed around the axis O1 is fixed to the minute hand 11, and the driven magnet 111 is arranged opposite to the drive magnet 112 located below the driven magnet 111 and disposed around the axis O1. The S and N poles of the driven magnet 111 and the drive magnet 112 attract each other to keep the minute hand 11 balanced between the distal end 11a and the rear end 11b. Therefore, the rear end 11b of the minute hand 11 can be shortened, and the sign can be arranged near the axis O1 but not hidden by the rear end 11b.

For example, the first sign 61 and second sign 62 are arranged so that when the minute hand 11 and hour hand 12 overlap, the through hole 12c in the hour hand 12 overlaps the through hole 11c in the minute hand 11, so that the user can still see the signs when the minute hand 11 and hour hand 12 are overlapped.

For example, by making the through hole 12c in the hour hand 12 larger than the through hole 11c in the minute hand 11, the time that the sign is hidden can be reduced.

For example, the hour hand 12 has the support 12e that supports the through hole 12c, which ensures the durability of the hour hand 12 even when the through hole 12c is enlarged.

For example, the CPU 41 can estimate the positions of the minute hand 11 and hour hand 12 based on the current time information obtained by the timekeeping circuit 46, and control the digital display 60 to change the position of the first sign 61 or second sign 62 based on the positions of the minute hand 11 and hour hand 12 so that the first sign 61 and the second sign 62 always can be displayed in an easily viewable manner.

For example, the CPU 41 can estimate the positions of the minute hand 11 and hour hand 12 based on the current time information obtained by the timekeeping circuit 46, and control the digital display 60 so that it does not display information of the portion covered by the minute hand 11 or hour hand 12, thereby reducing power consumption. In addition, visibility can be improved by preventing the display from becoming difficult to see due to unnecessary display.

For example, the minute and hour hands 11 and 12 have differently shaped luminescent parts 11d and 12d, respectively, so that the user can identify the minute and hour hands 11 and 12 in the dark.

For example, the luminescent part 11d of the minute hand 11 has a through hole 11e (window hole), and the hour hand 12 has a luminescent part 12d at a position visible through the through hole 11e in the luminescent part 11d when it overlaps the minute hand 11, so that the user can see the luminescent part 12d of the hour hand 12 even when the minute hand 11 overlaps the hour hand 12.

The description in the above embodiments is a suitable example of the embodiments pertaining to the present disclosure and the present disclosure is not limited thereto. For example, in the above embodiment, the first sign 61 and second sign 62 are described as being displayed on the digital display 60 of the dial 6, but they may also be printed on the dial 6. The type and number of multiple signs displayed on the dial 6 are not limited.

Other detailed configuration and operation of the timepiece 1 can also be changed as needed without departing from the purpose of the present disclosure.

Although the embodiments of the present disclosure have been described above, the technical scope of the present disclosure is not limited to the embodiments described above, but is defined based on the claims. Furthermore, the technical scope of the disclosure includes an equal scope with changes from the claims that have nothing to do with the essence of the disclosure.

1. A timepiece comprising:
a dial on which a first sign and a second sign are arranged, the first sign indicating a first display content and the second sign indicating a second display content which is different from the first display content; and
a hand that moves above the dial,
wherein
the hand has a through hole to allow visibility of the dial arranged below the hand, and
the first sign and the second sign are arranged at a position through which the through hole passes when the hand is moved.

2. The timepiece according to claim 1, wherein
the dial includes a digital display that displays information including the first sign and the second sign, and
the first sign and the second sign are icons displayed at a predetermined timing.

3. The timepiece according to claim 1, wherein
the first sign and the second sign are different from each other in shape.

4. The timepiece according to claim 1, wherein
a first magnetic body arranged around a rotation axis of the hand is fixed to the hand, and
the first magnetic body is arranged opposite a second magnetic body located below the first magnetic body and arranged around the rotation axis.

5. The timepiece according to claim 4, wherein
the first sign and the second sign are arranged at a position on the dial, the position being not hidden by a rear end of the hand.

6. The timepiece according to claim 1, wherein
the first sign and the second sign are arranged apart from each other.

7. The timepiece according to claim 1, wherein
the hand includes an hour hand and a minute hand, and
the first sign and the second sign are arranged at a position where a through hole in the hour hand and a through hole in the minute hand overlap when the hour hand and the minute hand overlap.

8. The timepiece according to claim 1, wherein
the hand includes an hour hand and a minute hand, and
a through hole in the hour hand is larger than a through hole in the minute hand.

9. The timepiece according to claim 8, wherein
the hour hand includes a support that supports the through hole in the hour hand.

10. The timepiece according to claim 1, further comprising:
a timekeeper to acquire current time information; and
a processor, wherein
the dial includes a digital display that displays information including the first sign and the second sign, and
the processor estimates a position of the hand based on the current time information acquired by the timekeeper and controls the digital display to change the position of the first sign or the second sign based on the estimated position of the hand.

11. The timepiece according to claim 1, further comprising:
a timekeeper to acquire current time information; and
a processor, wherein
the dial includes a digital display that displays information including the first sign and the second sign, and
the processor estimates a position of the hand based on the current time information acquired by the timekeeper and controls the digital display not to display the information of a portion covered by the hand.

12. The timepiece according to claim 1, wherein
the hand includes an hour hand and a minute hand, and
each of the hour hand and the minute hand has a luminescent part, and the luminescent part of the hour hand and the luminescent part of the minute hand have different shapes from each other.

13. The timepiece according to claim 12, wherein
an upper-arranged hand among the hour hand and the minute hand has a window hole, and
a lower-arranged hand among the hour hand and the minute hand has the luminescent part at a position that is visible through the window hole in the upper-arranged hand when the lower-arranged hand overlaps with the upper-arranged hand.
